(19) United States
(12) Patent Application Publication
(10) Pub. No.: US 2017/0300447 A1
(43) Pub. Date: Oct. 19, 2017

(54) SYSTEM ON A CHIP HAVING HIGH OPERATING CERTAINTY

(71) Applicant: Safran Electronics & Defense, BOULOGNE-BILLANCOURT (FR)

(72) Inventors: Celine LIU, BOULOGNE-BILLANCOURT (FR); Nicolas CHARRIER, BOULOGNE-BILLANCOURT (FR); Nicolas MARTI, BOULOGNE-BILLANCOURT (FR)

(21) Appl. No.: 15/516,994

(22) PCT Filed: Oct. 7, 2015
(86) PCT No.: PCT/EP2015/073183

§ 371 Date: Apr. 5, 2017

(30) Foreign Application Priority Data
Oct. 7, 2014 (FR) 1459607

(51) Int. Cl. G06F 13/40; G06F 11/07; G06F 13/28

(52) U.S. Cl. CPC G06F 13/4068; G06F 13/28; G06F 11/0736; G06F 11/0757; G06F 11/079

(57) ABSTRACT

The invention concerns a system on a chip (100) comprising a set of master modules which includes a main processing module (101a) and a direct memory access controller (DMA) (102a) associated with said module (101a), and at least one secondary processing module (101b) and a DMA (102b) associated with said module (101b), and slave modules; each master module being configured for connection to a clock source, a power supply, and slave modules which include a set of proximity peripherals (105a,b), at least one internal memory (104a,b) and a set (106) of peripherals and external memories shared by the master modules; said clock source, power supply, proximity peripherals (105a,b) and a cache memory (103a,b) of a master processing module and its DMA being dedicated to said master processing module and not shared with the other processing modules of the set of master modules; and said at least one internal memory (104a,b) of each master processing module and its DMA being dedicated to said master processing module, said main processing module (101a) being nevertheless able to access same.

### GENERAL TECHNICAL FIELD

The invention relates to the field of systems on chip (SOC).

The invention more particularly concerns the architecture of a system embedded on a chip having high dependability.

### PRIOR ART

The presence of control and display systems in modern aircraft requires the use of embedded computing means. Such means can appear in the form of system on chip (SOC). Such a system can comprise one or more master processing modules such as processors, and slave modules such as memory interface or communication peripherals.

The use of such systems on chip for critical applications such as the piloting and monitoring of an aircraft in the field of aerospace requires that these systems have maximum dependability, since any fault or anomaly of operation can have catastrophic consequences on the life of the aircraft occupants. It is necessary in particular to be able to prove the determinism of the operation of the component, its resistance to faults and its Worst Case Execution Time.

However, existing systems on chip do not make it possible to ensure adequate dependability for such critical applications. Specifically, the different processing modules of an existing system on chip generally share part of the cache memory and the slave modules of the system, which makes them subject to faults. In addition, existing systems do not generally make it possible to de-activate their unused modules, have an embedded microcode that is hard to certify and lack documentation, which makes it difficult to prove the determinism of their operation.

There is therefore a need for a system on chip offering an architecture making it possible to prove its resistance to internal operating faults and to prove the determinism of its operation.

### PRESENTATION OF THE INVENTION

The present invention thus relates in a first aspect to a system on chip (SoC) comprising a set of master modules and slave modules, said master modules being from among:
a main processing module having priority access rights over all the components of the system on chip and a direct memory access (DMA) controller associated with said main processing module;
at least one secondary processing module and a direct memory access (DMA) controller associated with each secondary processing module; each master module being configured to be connected to a clock source, a power supply, and slave modules from among:
a set of peripherals connected to the master module by a dedicated communication link, so-called “proximity peripherals”,
at least one internal memory,
a set of peripherals and external memories shared by the master modules,
   characterized in that
   said clock source, the power supply, the proximity peripherals and a cache memory of a master processing module and its direct memory access (DMA) controller are dedicated to said master processing module and not shared with the other processing modules of the set of master modules, said at least one internal memory of each master processing module and its direct memory access (DMA) controller is dedicated to said master processing module, said main processing module being nonetheless able to access it.

Such an architecture makes it possible to segregate each processing module accompanied by its direct memory access controller, its proximity peripherals and its internal memory from the rest of the system on chip. Such a segregation makes it possible to reinforce the determinism of operation of the system as well as its fault resistance.

According to an advantageous and non-limiting feature, the main processing module can be connected by at least one communication bus to the internal memories of the secondary processing modules.

The main processing module can thus access the contents of all the internal memories while preserving the integrity of the internal memory of this main processing module which on the contrary is not accessible to the other processing modules.

Moreover, the system according to the first aspect can comprise at least two stages of interconnections:
a first stage connecting each master module to its internal memory,
a second stage connecting the master modules to slave modules of the set of shared peripherals and external memories,
   said slave modules being distributed, according to their functions, their priorities and/or their bandwidth requirements, across several interconnects without direct communication with each other,
   an interconnect being composed of several master ports connected to several slave ports via one or more stages of switches.

This makes it possible to reduce the number of master and slave modules connected to one and the same interconnect and therefore to reduce the complexity of the arbitration and improve the determinism and dependability of the system on chip. The dependability of the system is also reinforced by the impossibility of direct communication between two slave modules connected to two different interconnects without going through a master module.

In addition, said second interconnect stage and the set of shared peripherals and external memories can be connected to a clock source and power supply separate from those of said master modules.

This reinforces the fault resistance of the system on chip.

In addition, said system can comprise an external master able to be connected to the shared peripherals by the interconnects of the second interconnect stage.

This allows the system on chip to give access to its slave modules to an external component.

Moreover, the proximity peripherals and the internal memory of a master module can be connected to the power supply and to the clock source of this master module.

The communication interface of the proximity peripherals of a master module with this master module can, as an alternative, be connected to the clock source of this master module.

In another alternative, the proximity peripherals and the internal memory of a master module can be connected to a dedicated power supply and clock source.

This reinforces the fault resistance of the system on chip by preventing a clock or power supply fault from affecting the proximity peripherals or the internal memories of several processing modules.

By way of example, the proximity peripherals of a master module can be a reset controller, a watchdog, an interrupt controller, a real-time controller, peripherals specific to aerospace applications, or a direct memory access (DMA) controller.

The proximity peripherals of a secondary processing module can be a real-time controller, a watchdog, a direct memory access (DMA) controller, or an interrupt controller.

This allows each processing module to directly access these peripherals always with the same access time, without any additional latency due to a competing access from another master module.

Moreover, the interconnects can be:
an external memory interconnect grouping together a set of slave modules controlling external memories and/or series links such as SPI (“Serial Peripheral Interface”) links for the interface with the external memories;
a communication interconnect grouping together a set of slave modules comprising communication peripherals, for example one of: Ethernet, ARINC, UART (“Universal Asynchronous Receiver Transmitter”), SPI (“Serial Peripheral Interface”), AFDX (“Avionics Full DupleX switched Ethernet”), A429 (ARINC 429), A825 (ARINC 825), CAN (Controller Area Network), or I2C.
a control interconnect grouping together a set of slave modules comprising control peripherals for aerospace-specific applications, for example control modules configured to implement functions specific to engine control or braking computing;
a customization interconnect connected to a programmable area for the addition of customized functions;

This makes it possible to limit the number of slave modules connected to each interconnect and to group the slave modules on one and the same interconnect according to their function in order to reduce the complexity of the internal structure of these interconnects.

Each interconnect can comprise monitoring and fault detection mechanisms.

This makes it possible to monitor the exchanges between modules at the interconnects in order to avoid transmitting erroneous commands or data and also to avoid blocking an interconnect due to a malfunction in one of the modules.

By way of example, the different stages of internal switches at each interconnect can be grouped together in the following way:
the master modules are grouped together into groups of master modules at a first stage of first switches according to the slave modules to which they must be able to connect, their function, their priority and/or their bandwidth requirement, each group of master modules being connected to a switch,
the outputs of these first switches are connected to a second stage of switches grouping slave modules into groups of slave modules as a function of the master modules that are connected thereto, their function and/or bandwidth requirement, a single communication link connecting a group of master modules and a group of slave modules.

In addition, said slave modules can be grouped together into groups of slave modules from among the following groups:
slave modules dedicated to the main processing module using a fast communication bus,
slave modules dedicated to the main processing module using a slow communication bus,
slave modules shared between the different groups of master modules using a fast communication bus,
slave modules shared between the different groups of master modules using a slow communication bus.

This reduces the number and complexity of the internal physical paths of the interconnect and reduces the number of switch stages and the number of switches so that the latency of the interconnect is smaller and the arbitration less complex.

The processing modules can be arranged in the system on chip so as to be physically segregated. This makes it possible to reduce the probability of a common fault in the event of an alteration of SEU (“Single Event Upset”) or MBU (“Multiple Bit Upset”) type.

### PRESENTATION OF THE FIGURES

Other features and advantages will become apparent upon reading the following description of an embodiment. This description will be given with reference to the appended drawings wherein:

FIG. 1 schematically illustrates the architecture of a system on chip according to an embodiment of the invention;

FIG. 2 represents a detailed example of a system on chip according to an embodiment of the invention;

FIG. 3 illustrates the architecture of an interconnect in a system on chip according to an embodiment of the invention;

FIG. 4 represents an example of interconnect architecture of the prior art;

FIG. 5 represents an example of interconnect architecture according to an embodiment of the invention.

### DETAILED DESCRIPTION

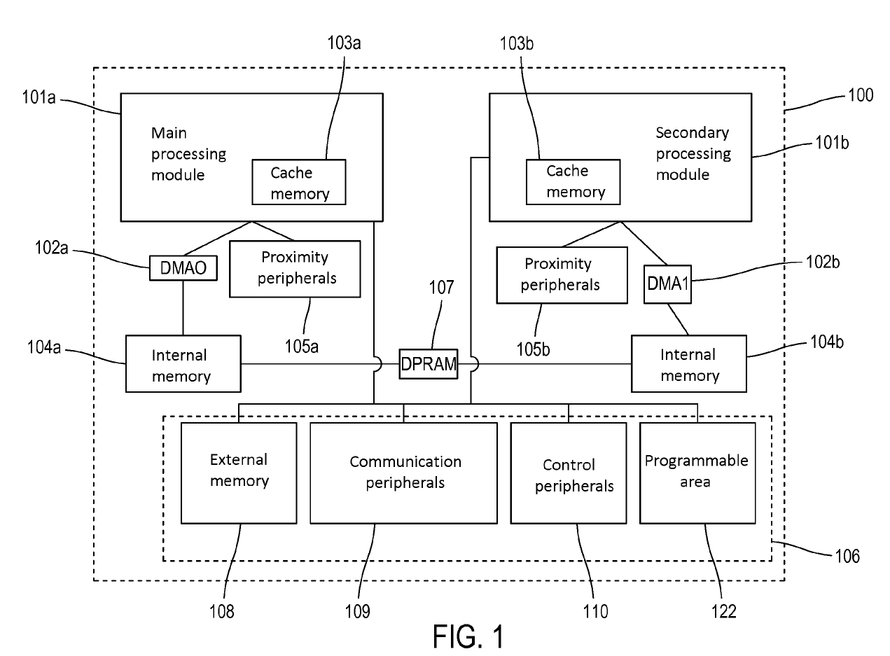

With reference to FIG. 1, an embodiment of the invention concerns a system on chip 100 (SoC).

Such a system comprises a set of master modules and slave modules. The system 100 comprises, among these master modules, processing modules such as processors or cores of a multi-core processor; such processors can belong to various families of processor.

The system 100 particularly comprises, among these master modules, a main processing module 101a and one or more secondary processing modules 101b. The main processing module has access to all the resources activated in the system and controls its proper operation. The secondary processing modules can be used as co-processors to supply an additional computing power or specific functionalities, or permit maintenance. The system on chip 100 can also comprise as master module a direct memory access controller (DMA0, DMA1) 102a, 102b associated with each processing module and lightening the load on the processing modules for the handling of data transfers. An equivalent system could be envisioned without DMA, the processing modules then handling the data transfers with the memory.

Each processing module 101a, 101b comprises a cache memory 103a, 103b. The cache memory of each processing module is specific thereto and is not shared with the other processing modules in order to ensure complete segregation of the processing modules and reduce the risk of common-mode failure.

In the same way, each processing module is connected to a power supply source and a clock source which are specific to it. This ensures the independence of the processing modules with respect to each other and reduces the probability of a common fault in the event of a fault in the power supply or the clock source of one of the processing modules.

The processing modules can also be physically segregated by being arranged on the embedded system in separate locations spaced apart from one another, for example by arranging them each at one corner of the component. This makes it possible to reduce the probability of a common fault in the event of an alteration of SEU (“Single Event Upset”) or MBU (“Multiple Bit Upset”) type.

In order to reduce conflicts between the different processing modules, the main processing module 101a is the only master module having access rights to all the components of the system on chip 100. In addition, the main processing module has priority over all the other master modules in all these accesses to the slave modules of the system on chip 100. The determinism of the operation of the system on chip 100 is thus reinforced.

In addition, the main processing module 101a controls the activation and deactivation of all the other modules of the system on chip 100, including the secondary processing modules. The main processing module can reset a secondary processing module. The main processing module 101a is also in charge of analyzing the state of health of the system on chip 100 and assigning penalties when a fault is detected. The processing module 101 can thus deactivate the modules that are unused or that exhibit erroneous behavior in the event of a fault.

Advantageously, the main processing module 101a is always active. It is particularly used for all applications only requiring the use of a single processing module.

Moreover, the system 100 can make provision for a connection for an external master 111 so as to give access thereto to the slave modules of the system on chip 100. Such an external master can consist in a core, a processor or a microcontroller, or else of another peripheral.

Each master module can be connected to slave modules from among:
at least one internal memory 104a, 104b,
a set of peripherals connected to the master module by a dedicated communication link, so-called “proximity peripherals” 105a, 105b,
a set of peripherals and external memories 106 shared by the master modules.

The internal memory 104a, 104b of a processing module and its direct memory access DMA controller is dedicated to this processing module and is not shared with the other processing modules.

However, the main processing module 101a can access all the internal memories of all the secondary processing modules 101b, for example to perform data monitoring or to use the memory area of an inactive secondary processing module to extend its internal storage capacity. To do this, the main processing module can be linked by at least one communication bus directly to the internal memories of the secondary processing modules. It is possible that the system comprises a separate bus for each link between the main processing module and an internal memory of a secondary processing module. Alternatively, a common bus can be employed to link the main processing module to several secondary processing modules, optionally with an added multiplexer to manage exchanges on the bus and manage priorities.

Conversely, the secondary processing modules are not physically linked to the internal memory of the main processing module in order to guarantee the segregation of the main processing module.

The external master does not have access to the internal memories of the various processing modules either. This also makes it possible to guarantee for the main processing module a constant time of access to its internal memory.

Such an internal memory can consist in an internal direct-access RAM (Random Access Memory) memory and/or a flash memory. Each processing module can be linked to its internal memory by way of a bus of AXI-M type.

The internal memory of a processing module can be connected to the clock source and to the power supply of this processing module so as to reduce the probability of a common-mode fault. To reinforce the segregation, this internal memory can also be connected to a power supply and clock source.

In addition to the main processing module's means of direct access to the internal memories of the secondary processing modules, the system on chip 100 can comprise an additional memory 107, for example of DPRAM (Dual Ported Random Access Memory) type, dedicated to the exchange of data between two processing modules and accessible by these processing modules. A first processing module can write data to this memory, which data is thus made available to the other processing modules without the latter having to directly access the internal memory of the first processing module. In the event of a plurality of secondary processing modules, it is possible to make provision for such an additional memory for each secondary processing module, linked to this secondary processing module and to the main processing module.

Each processing module can also be linked to proximity peripherals 105a, 105b. Such peripherals are dedicated to each processing module and are accessible by it alone in order to ensure the segregation of the processing modules from each other and to reduce the probability of a common-mode fault. The external master does not have access to these proximity peripherals either. This makes it possible to not have any arbitration to carry out between the different processing modules and therefore to reinforce the determinism of operation of the system on chip 100.

Each processing module can thus be connected to the standard proximity peripherals of existing processors, such as the following proximity peripherals:
a watchdog (WD) to ensure the proper execution of an application by the processing module ,
a real-time controller (RTC) to synchronize the execution of an application,
a direct memory access (DMA) controller to manage the operation of the DMA module of the processing module,
an interrupt controller (IRQ),
a reset controller,
peripherals specific to aerospace applications.

Unlike the main processing module, the secondary processing modules are not connected to such monitoring and configuration peripherals since they only require peripherals for ensuring their own proper operation.

Like the internal memory, the proximity peripherals of a processing module can be connected to the clock source and to the power supply of this processing module so as to reduce the probability of a common-mode fault. Alternatively, in order to further reinforce the fault resistance, only the communication interface of the proximity peripherals 105a, 105b of a processing module with this processing module is connected to the clock source of this processing module and the processing modules are connected to a separate power supply. In order to reinforce the segregation, the proximity peripherals can also be connected to a dedicated power supply and clock source.

Each processing module can be connected to its proximity peripherals by way of a bus of AHB-PP (Advanced High-performance Bus) type.

Each processing module therefore has its own cache memory, internal memory and proximity peripherals, not shared with the other processing modules of the system on chip 100, powered by its own power supply and clock source.

In addition, the main processing module is the only one to have access to all the modules of the system on chip, as a priority, and to possess peripherals for monitoring and configuration of the system on chip.

Such an architecture maximizes the segregation of the different processing modules, minimizes the probability of common-mode fault and reinforces the determinism of operation of the system on chip.

Each master module can also be connected to a set of peripherals and external memories 106 shared by the master modules as represented in FIG. 1.

As indicated above, the main processing module systematically takes priority over the other processing modules for its accesses to the shared peripherals and external memories 106.

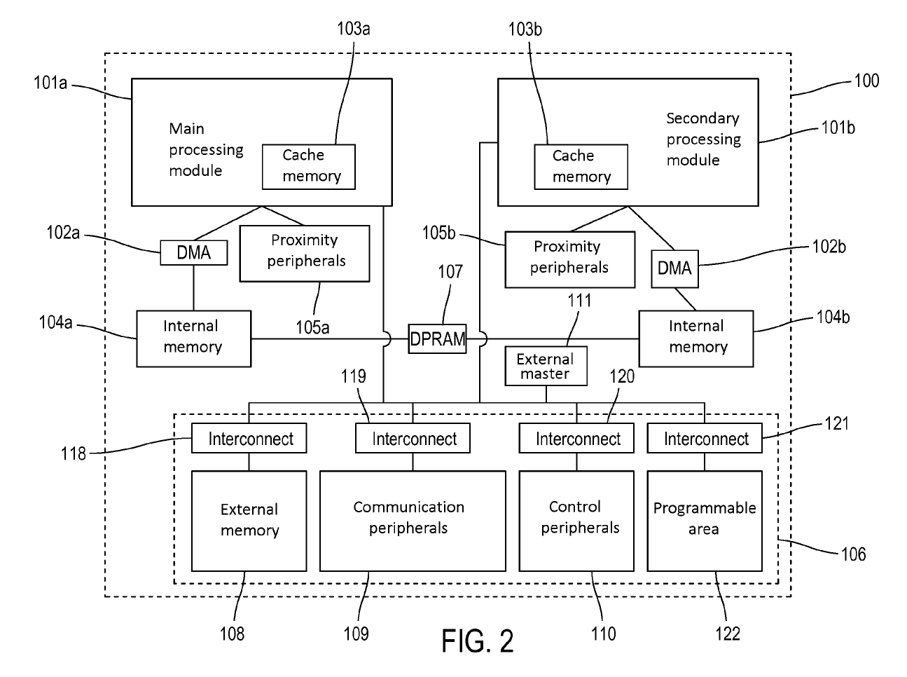

The details of the types of shared peripherals and external memories to which the master modules can be connected are described in the paragraphs below and illustrated in FIGS. 1 and 2.

Each master module can in particular be connected to external memory controllers 108 such as SDRam (Synchronous Dynamic Random Access Memory)/DDR (Double Data Rate) or flash memory controllers, or of QSPI (Quad Serial Peripheral Interface) memory or controllers.

The external master cannot have access to the external memory controllers 108.

Each master module can also be connected to communication peripherals 109 such as AFDX (Avionics Full Duplex), μAFDX, A429, Ethernet, UART, SPI, I2C, or A285/CAN controllers.

Each master module can also have access to control peripherals 110 for aerospace-specific applications. Such peripherals can notably be configured to implement functions specific to engine control or to braking computing such as a sensor acquisition function (ACQ), a control function (ACT), a protection function (PROTECT) or an inter-computer link function (LINK).

Finally each master module can be connected to a programmable area 122 composed of FPGA (Field Programmable Gate Array) circuits allowing the addition of customized functions to the system on chip.

All the shared peripherals and external memories 106 can be connected to a clock source and power supply separate from those to which the processing modules are connected. The communication interface of the proximity peripherals 105a, 105b of a master module with this master module can also be connected to the clock source of this master module. The probability of a common-mode fault affecting a considerable portion of the system on chip following a fault of the clock source or power supply is thus reduced.

The master modules are connected to the slave modules by way of interconnection networks referred to as interconnects.

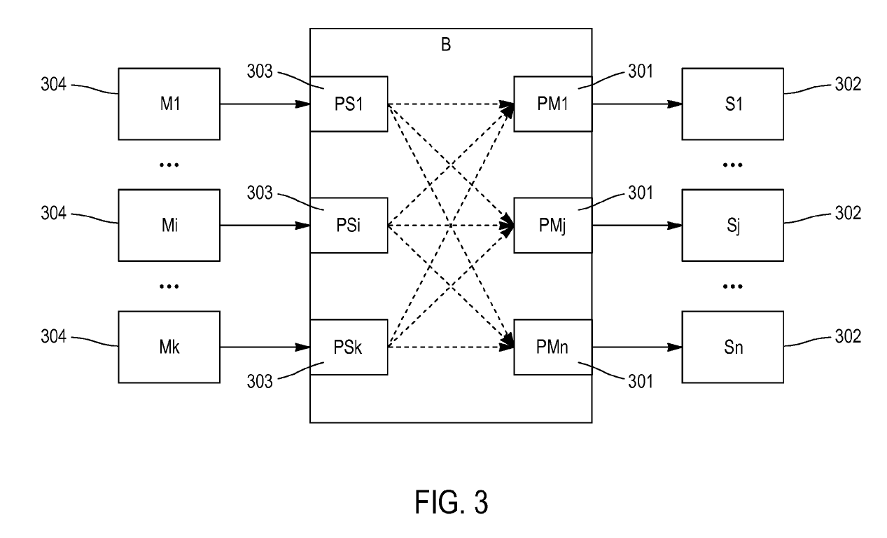

As represented in FIG. 3, an interconnect is composed of master ports 301 to each of which is connected a slave module 302, connected through one or more stages of switches to slave ports 303 to each of which a master module 304 is connected.

A first interconnect stage can be used to connect the master modules to the internal memory, and where applicable to the external memory if it is not shared. As represented in FIG. 2, a second interconnect stage can be used to connect the master modules to the slave modules of the set of peripherals. Each interconnect stage can include one or more interconnects.

In such an architecture, in which the peripherals and shared memories are not connected to the same clock source as that of the master modules, the first interconnect stage also serves to resynchronize the signals of the master modules to a clock domain identical to that of the shared peripherals 106.

The first interconnect stage can then include two interconnects for each processing module: one interconnect for connecting the masters to the internal memory and to the external memory via the external memory controllers, and an intermediate interconnect between the processing module and the second stage for connecting the shared peripherals. These two interconnects can be connected to the same clock sources and power supply as those of the processing module on which they depend.

At the second interconnect stage, the slave modules are distributed across several interconnects according to their functions, their priorities and/or their bandwidth requirements. This makes it possible to reduce the number of slave modules connected to one and the same interconnect and therefore to reduce the complexity of the arbitration and to improve the determinism and dependability of the operation of the system on chip.

One interconnect can be used for each category of modules among the set of shared peripherals and memories described above, namely:
one external memory interconnect 118 grouping together a set of slave modules controlling external memories and/or series links such as SPI for the interface with the external memories;
one communication interconnect 119 grouping together a set of slave modules comprising communication peripherals,
a control interconnect 120 grouping together a set of slave modules comprising control peripherals for aerospace-specific applications;
a customization interconnect 121 connected to a programmable area for the addition of customized functions.

No direct communication is possible between two interconnects of the second interconnect stage. The transmission of data between two of these interconnects is therefore only possible at the request of a master module.

An additional interconnect can also be used to connect each lo processing module to its proximity peripherals if the connection employed between a processing module and its proximity peripherals is not multiport.

Each interconnect can also comprise mechanisms dedicated to monitoring data exchanges over the interconnect and for detecting any faults. Such mechanisms can for example be used to avoid the internet being blocked in the event of an interruption of a data exchange in progress, to check the access rights of a master module to a slave module when there is a data exchange request, and also to monitor the transactions on AXI and AHB buses.

In existing systems, the interconnects generally connect each of the master ports to each of the slave ports independently of the other links provided by the interconnect. The number of links internal to the interconnect and the number of switches to be used then increase very quickly with the increase in the number of master and slave modules connected to the interconnect.

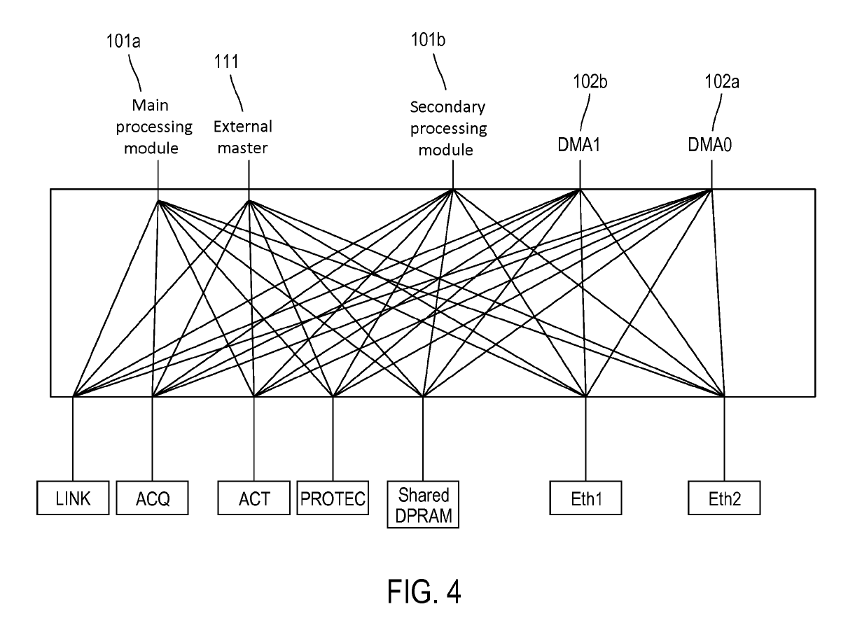

By way of example, the application of such an interconnect construction strategy to the control interconnect described above would lead to an architecture such as that represented in FIG. 4. Such an architecture is not desirable in the context of a system on chip used for aerospace applications due to its complexity and the arbitration problems generated by this complexity.

The system on chip according to the invention proposes a new interconnect construction strategy wherein the master modules are grouped together into groups of master modules at a first stage of first switches according to the slave modules to which they must be able to connect, their function, their priority and/or their bandwidth requirement, each group of master modules being connected to a switch. Thus the first stage of switches of the interconnect includes at the most as many switches as groups of masters.

The outputs of these first switches are then connected to a second stage of switches grouping slave modules into groups of slave modules as a function of the master modules that are connected thereto, their function and/or their bandwidth requirement, one single communication link connecting one group of master modules and one group of slave modules.

The slave modules can for example be grouped together into groups of slave modules, from among the following groups:
slave modules dedicated to the main processing module using a fast communication bus,
slave modules dedicated to the main processing module using a slow communication bus,
slave modules shared between the different groups of master modules using a fast communication bus,
slave modules shared between the different groups of master modules using a slow communication bus.

Thus the second stage of switches includes at the most as many switches as groups of slave modules and the interconnect includes at the most as many internal physical paths as the product of the number of groups of master modules by the number of groups of slave modules.

Such an interconnect generation strategy reduces the number and complexity of the internal physical paths of the interconnect and reduces the number of switch stages and the number of switches so that the latency of the interconnect is smaller and the arbitration less complex and deterministic.

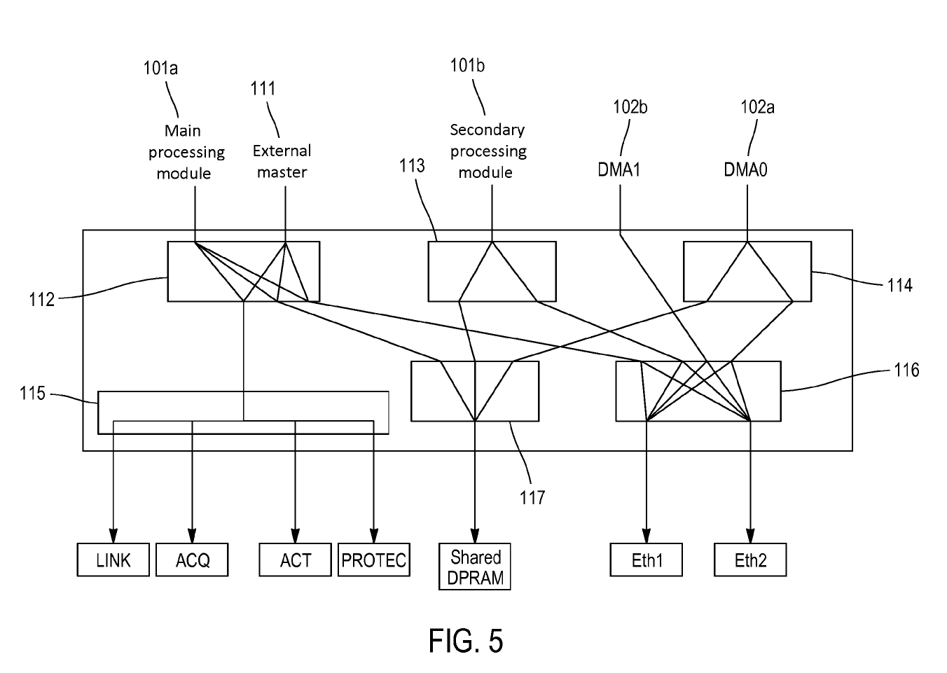

By way of example the application of such a strategy to the control interconnect described above is illustrated in FIG. 5.

The main processing module 101a and the external master 111 are the only master modules to have access to all the slave modules connected to the control interconnect. These two master modules are therefore grouped together into a first group of master modules on a first switch 112.

The secondary processing module 101b and the DMA 102a (DMA0) of the main processing module have access to the same slave modules, namely the shared memory 107 and the Ethernet controllers. They can therefore be grouped together into a second group of master modules on a second switch. However, their bandwidth requirements being very different, the choice can be made to keep them separated and connected to two different switches 113 and 114. A different switch can therefore be used for each of these master modules.

Finally, as the DMA 102b (DMA1) of the secondary processing module has access only to the Ethernet controllers, it is not grouped with the master modules previously mentioned either.

On the slave module side, as modules such as a LINK intercomputer link module, an acquisition unit ACQ, a control unit ACT and a protection module PROTEC are accessible only by the master modules of the first group of master modules defined above and grouping together the main processing module and the external master, these slave modules are grouped together into a first group of slave modules. All these modules are connected to the same switch 115 of the second stage of switches of the interconnect.

A single physical link connecting the switch of the first group of master modules to the first group of slave modules is then necessary to connect the main processing module 101a and the external master 111 to all the slave modules of the first group of slave modules.

In the same way, the two Ethernet controllers having similar functions are grouped according to their function into a second group of slave modules on a second switch 116 of the second stage of switches of the interconnect.

Finally an additional switch 117 is used to connect the different switches of the first stage of switches of the interconnect to the shared-memory slave module.

As the DMA 102b of the secondary processing module is connected only to the Ethernet controllers, no additional switch is required at the first stage of the interconnect to connect the DMA 102b to the switch 116 grouping together the two Ethernet controllers.

In total, the control interconnect thus formed requires only six switches 112 to 117 and eight internal physical links to interconnect five master modules and seven slave modules.

In order to reinforce the determinism of the operation of the system on chip and to reduce the latency by reducing the arbitration, each interconnect can be configured in such a way as to systematically give priority to the physical links connected to the switch of the main processing module or to the group of master modules comprising the main processing module.

The invention therefore proposes a system on chip exhibiting high dependability owing to the determinism of its operation and its fault resistance. Such a system can therefore be used for critical applications in the aerospace field such as control of the engine, the brakes, or the electrical actuators of an aircraft. Such a system on chip can also be used in other fields requiring high dependability such as the automotive sector, the medical field etc.

1. A system on chip comprising a set of master modules and slave modules,
said master modules being from among:
a main processing module having priority access rights over all the components of the system on chip and a direct memory access controller associated with said main processing module;
at least one secondary processing module and a direct memory access controller associated with each secondary processing module;
each master module being configured to be connected to a clock source, a power supply, and slave modules from among:
a set of peripherals connected to the master module by a dedicated communication link, so-called “proximity peripherals”,
at least one internal memory,
a set of peripherals and external memories shared by the master modules,
wherein
said clock source, the power supply, the proximity peripherals and a cache memory of a master processing module and its direct memory access controller are dedicated to said master processing module and not shared with the other processing modules of the set of master modules,
said at least one internal memory of each master processing module and its direct memory access controller is dedicated to said master processing module, said main processing module being nonetheless able to access it.

2. The system according to claim 1, wherein said main processing module is connected by at least one communication bus to the internal memories of the secondary processing modules.

3. The system according to claim 1, comprising at least two stages of interconnections:
a first stage connecting each master module to its internal memory,
a second stage connecting the master modules to slave modules of the set of shared peripherals and external memories, said slave modules being distributed, according to functions of said slave modules, the priorities of said modules and/or bandwidth requirements of said slave modules, across several interconnects without direct communication with each other,
an interconnect being composed of several master ports connected to several slave ports via one or more stages of switches.

4. The system according to claim 3, wherein said second interconnect stage and the set of shared peripherals and external memories are connected to a clock source and power supply separate from those of said master modules.

5. The system according to claim 3, comprising an external master able to be connected to the shared peripherals by the interconnects of the second interconnect stage.

6. The system according to claim 1, wherein the proximity peripherals and the internal memory of a master module are connected to the power supply and to the clock source of this master module.

7. The system according to claim 1, wherein the communication interface of the proximity peripherals of a master module with this master module is connected to the clock source of this master module.

8. The system according to claim 1, wherein the proximity peripherals and the internal memory of a master module are connected to a dedicated power supply and clock source.

9. The system according to claim 1, wherein the proximity peripherals of a master module are among a reset controller, a watchdog, an interrupt controller, a real-time controller, peripherals specific to aerospace applications, or a direct memory access controller.

10. The system according to claim 1, wherein the proximity peripherals of a secondary processing module are among a real-time controller, a watchdog, a direct memory access controller, or an interrupt controller.

11. The system according to claim 3, wherein the interconnects are among:
an external memory interconnect grouping together a set of slave modules controlling external memories and/or series links for the interface with the external memories;
a communication interconnect grouping together a set of slave modules comprising communication peripherals,
a control interconnect grouping together a set of slave modules comprising control peripherals for aerospace-specific applications;
a customization interconnect connected to a programmable area for the addition of customized functions.

12. The system according to claim 11, wherein the communication interconnect groups together a set of communication peripherals from among: Ethernet, ARINC, UART (“Universal Asynchronous Receiver Transmitter”), SPI (“Serial Peripheral Interface”), AFDX (“Avionics Full DupleX switched Ethernet”), A429 (ARINC 429), A825 (ARINC 825), CAN (Controller Area Network), or I2C.

13. The system according to claim 11, wherein the control interconnect groups together control modules configured to implement functions specific to engine control or braking computing.

14. The system according to claim 3, wherein each interconnect comprises monitoring and fault detection mechanisms.

15. The system according to claim 3, wherein the different stages of internal switches at each interconnect are grouped together in the following way:
the master modules are grouped together into groups of master modules at a first stage of first switches according to the slave modules to which they must be able to connect, their function, their priority and/or their bandwidth requirement, each group of master modules being connected to a switch,
the outputs of these first switches are connected to a second stage of switches grouping slave modules into groups of slave modules as a function of the master modules that are connected thereto, their function and/or bandwidth requirement, a single communication link connecting a group of master modules and a group of slave modules.

16. The system according to claim 15, wherein said slave modules are grouped together into groups of slave modules from among the following groups:
slave modules dedicated to the main processing module using a fast communication bus,
slave modules dedicated to the main processing module using a slow communication bus,
slave modules shared between the different groups of master modules using a fast communication bus,
slave modules shared between the different groups of master modules using a slow communication bus.

17. The system according to claim 15, wherein the processing modules are arranged in the system on chip so as to be physically segregated.
